(19) United States
(12) Patent Application Publication
(10) Pub. No.: US 2002/0085525 A1
(43) Pub. Date: Jul. 4, 2002

(54) Wireless transmission system

(76) Inventor: Junpei Ikegawa, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/026,516

(22) Filed: Dec. 27, 2001

(30) Foreign Application Priority Data
Dec. 28, 2000 (JP) 2000-400215
Sep. 18, 2001 (JP) 2001-282800

(51) Int. Cl. H04J 3/00

(52) U.S. Cl. 370/336; 370/345

(57) ABSTRACT

A wireless transmission system for conducting data transmission over a wireless field in which data transmission slots of a fixed size are periodically allocated to the wireless field is provided that prevents backup of wireless send queue members, thereby enabling efficient utilization of the wireless transmission medium. The wireless transmission system includes a memory for retaining a wireless send queue whose members are transmission data awaiting transmission, linking means for linking multiple transmission data to form members of the wireless send queue, wireless send means for loading a wireless send queue member output from the memory in a data transmission slot; and control means responsive to output of a wireless send queue member from the memory for controlling retention of a next wireless send queue member in the memory.

### BACKGROUND OF THE INVENTION

1. Field of the Invention

This invention relates to a technology for achieving efficient data transmission in wireless communication using data transmission slots of fixed length (data communications channels), e.g., a technology suitable for use in a subscriber wireless access system utilized for TDMA/TDD (time division multiple access/time division duplex) wireless communication between wireless communication stations.

2. Description of the Prior Art

A number of different subscriber wireless access systems that utilize wireless communications are known, including, for example, WLL (wireless local loop) and FWA (fixed wireless access). As illustrated in the example shown in FIG. 1, a subscriber wireless access system provides telecommunications on a TDMA/TDD wireless field between a base station (BS) 1 installed at a fixed location by a telecommunications service provider and multiple customer stations (CS) 2 installed at fixed sites by the individual users. By making wireless communications possible between the base station 1 and the individual customer stations 2, the system enables data communications between LANs 3 connected to different customer stations 2. It also makes data communications with other customer LANs possible through a public telecommunications network, LAN or other backbone network 4 connected to the base station 1.

The base station 1 serves a large number of customer stations 2. A system like this that offers multidirectional wireless communications from a single facility is commonly referred to as a P-MP (point-to-multipoint) system.

Data transmission channels (data transmission time slots) are allocated for wireless communications between the base station 1 and the customer stations 2, and the base station 1 controls the allocation so that the customer stations 2 under it can share the data transmission channels.

When the base station 1 and the backbone network 4, or the customer stations 2 and the LANs 3, are connected by Ethernet® and IEEE 802.3 wired LAN interfaces, unicast data including the specific addresses of the customer terminals incorporated in the customer LANs 3 and broadcast data including the addresses allocated to the customer terminals are sent/received by wireless communications between the base station 1 and the customer stations 2. Large amounts of data are therefore wirelessly exchanged at frequent intervals.

In a wireless communications system utilizing TDMA/TDD, for example, each customer station 2 can send and receive transmission data (frames) only on a specific data transmission channel allocated and controlled by the base station 1. Owing to the nature of TDMA/TDD, the data transmission channel (data communications slot) allocated to the customer station 2 is of fixed length. The length of the data transmission channel is ordinarily set to be capable of storing the largest frame defined by Ethernet and IEEE 802.3.

However, since the Ethernet® and IEEE 802.3 data frames actually sent and received using the data transmission slot vary in length and data frames of different sizes are sent and received, much of the capacity of the allocated fixed-length data transmission slot goes unused. This makes efficient data transmission impossible and, by extension, prevents effective utilization of the wireless transmission medium.

More concretely, in a wireless transmission system that conducts data transmission on a wireless field using data transmission slots of fixed size, e.g., in a wireless transmission system that uses TDMA/TDD for wireless circuit control, data transmission time slots of a fixed size (data channels or Dchs) are allocated to the wireless field at a constant rate and the transmission data are transmitted on the wireless field carried by the allocated data transmission time slots.

Within the wireless transmission system, the data transmitted on the wireless field are, for instance, LAN frames, and in a wireless transmission system that transmits LAN frames without breaking them down (one with bridging capability), the Dch size is set at a minimum of 1518×8 bit time to permit transmission of the largest LAN frame (1518 bytes).

However, the actual size of the LAN frame can take any value between 64 and 1518 bytes. When only a single LAN frame is included in a single Dch as shown in FIG. 11, therefore, an empty region usually remains in the Dch and the Dch utilization rate (ratio of the transmission data to the Dch capacity) is therefore no very high.

If a chain of LAN frames can be included in a single Dch to minimize the empty region, the Dch utilization rate and, by extension, the transmission speed (transmission throughput) of the LAN frames on the wireless field, can be increased.

Consider, for example, the case where a wireless transmission system with a Dch size of 1518×8 bit time and a Dch transmission speed on the wireless field of 500 slots per second is continuously input with LAN frames of 64-byte size from the LAN side. Under these conditions, unlinked transmission and linked transmission can be compared as explained in the following.

(The explanation assumes that the CPU is fast enough to process linking of 22 frames within each Dch transmission period.)

(1) When Unlinked LAN Frames are Transmitted on the Wireless Field

In this case, the Dch utilization rate is (64/1518)×100=4.2%.

Since only one LAN frame is loaded in each Dch and wirelessly transmitted, the LAN frame transmission speed on the wireless field is equal to the Dch transmission speed (wireless speed) and the maximum transmission throughput is around 500 pps (packets per second).

(2) When Linked LAN Frames are Transmitted on the Wireless Field

When multiple LAN frames are linked, each LAN frame requires a region containing identification data for use in identifying the individual LAN frames (such as a front-end identifier or frame size data that can be used to determine the boundaries between the LAN frames). Assuming this to amount to 4 bytes and to be located at the head of the linked LAN frames, the number of linkable LAN frames becomes 1518/(64+4)=22 frames.

In this case, the Dch utilization rate is (64×22)/1518×100)=93%. The maximum LAN frame transmission speed on the wireless field becomes Dch transmission speed (=500)×number of linked LAN frames (=22)=11000 pps. The transmission throughput thus increases in proportion to the number of linked LAN frames and is 22 times that by the unlinked transmission of (1).

The necessity for linked transmission on the wireless field will now be explained from the viewpoint of actual LAN traffic flow.

In the explanation that follows, the largest LAN frame, which is too large to link, will be referred to as a “long frame” and LAN frames which are short enough to be linked within a single Dch will be referred to collectively as “short frames.” When data is transferred on a LAN using a file transfer protocol, typically FTP, long frames of maximum size (1518 byte) are produced continuously. Since these long frames cannot be linked, their transmission speed on the wireless field is fixed at the Dch transmission speed (wireless speed).

When executed, however, almost all protocols, including the aforesaid FTP, produce acknowledgement response packets at regular intervals.

As numerous messages are sent and received simultaneously using different protocols on a LAN, the overall number of short frames present is usually large.

Linking of the short frames for transmission on the wireless field is therefore considered essential for smooth handling of these numerous messages.

Moreover, Voice over IP (VoIP), a technology for using the Internet infrastructure as a telephone network, uses short frames of around 64 bytes to transmit voice messages.

VoIP operates at a speed of around 5 to 64 Kbps per channel (the speed varying with the voice encoding method). In the case of multichannel use, however, the short frame traffic increases in proportion to the number of channels.

As VoIP use is expected to expand markedly, adding further to the anticipated increase in LAN short frame traffic, high transmission throughput performance for short frames will also be required on the wireless field.

This makes it essential to boost short frame transmission throughput performance to a high level and, for this, to link short frames when transmitting them over the wireless field.

When linked frame transmission is implemented on the wireless field, the delay time required for transmission must be reduced to assure good service quality. In VoIP, for example, it is considered that the total data transmission delay time must be kept to within around 200 millisecond to ensure acceptable service quality. The delay time arising in the wireless transmission system must therefore be held to the very minimum.

Even in file transmission and other types of communication not requiring real-time capability, such as in communication using TCP (transmission control protocol), data transmission must stand by for a certain period after each transmission of a prescribed amount of data to wait for an acknowledgement response. It is known that this acknowledgement response wait time is determined by the delay time and that, therefore, among different transmission systems having the same bandwidth, those with longer delay times have lower effective throughput during communication. This is another reason why the delay time arising in the wireless transmission system needs to be minimized.

Random enqueuing and dequeueing at a single queue proceeds according to what is known in statistics as Poisson distribution. Based on this assumption, it is known from queuing theory that the “Queue population” is

ρ²/(1−ρ).

The “Delay time caused by the queue population” is therefore given by

ρ²/(1−ρ)×(1/dequeue rate) (A).

ρ represents the traffic density, defined as p (enqueue rate)/(dequeue rate), and is expressed in Erlangs.

From Eq. (A) it follows that the delay time caused by queue member congestion presents the profile shown in FIG. 12 with respect to the enqueue volume (LAN input load). That is, the delay time grows infinite as (enqueue rate) approaches (dequeue rate).

Queuing theory is considered to apply to the range of ρ<1, i.e., the range in which the enqueue rate is smaller than the dequeue rate.

Since a queue has finite depth (an upper limit of number of members that can be accommodated in the queue), the actual profile becomes as shown in FIG. 13.

As can be seen from FIG. 13, the delay time caused by backup of queue members is quite short in the range of ρ<1, i.e., when the dequeue rate is greater than the enqueue rate, but shoots up rapidly to the maximum delay time (13.1) as ρ moves past a certain point on its way toward ρ=1. The point at which this maximum delay time is reached determines the maximum transmission throughput of the system (the upper limit beyond which the system can no longer transmit with zero packet loss). The region beyond this is the so-called “congested state” (13.2) exceeding the upper limit of the system's processing capability.

Consideration will now be directed to queue formation within a wireless transmission system that wirelessly connects two or more LAN segments, such as a wireless LAN system or a FWA system.

This is usually as shown in FIG. 14, in which the queue on the send side composed of members waiting to be loaded in Dchs for transmission over the wireless field is represented by a wireless transmission queue (14.1) and the queue on the receive side composed of members received from the wireless field Dchs is represented by a wireless receive queue (14.2).

Fast Ethernet® (official known as IEEE 802.3 u), which is currently becoming the mainstream for LAN, offers data transmission speeds up to 100 Mbps. In comparison, the data transmission speed of LANs operating on the wireless field, as exemplified by the wireless LAN system based on the IEEEE 802.11 b High Rate standard, is a maximum of 11 Mbps.

In general, it is safe to assume that LAN speed is higher than wireless field speed. At the wireless receive queue (14.2), therefore, since WRXQout (14.5) (the dequeue rate from the wireless receive queue) is larger than WRXQin (14.6) (enqueue rate to the wireless receive queue), substantially no backup arises in the wireless receive queue (14.2). So almost no delay arises.

At the wireless send queue (14.1), on the other hand, the input traffic from the LAN sometimes exceeds the transmission processing capability of the wireless field. At such times, maximum backup occurs in the wireless send queue, resulting in a long delay time.

A situation in which the input traffic from the LAN comes to exceed the upper limit of the system transmission capability in this manner means that the system has entered a congested state. The delay produced in this state is basically impossible to avoid.

In actuality, however, when LAN frame linking and wireless send queue processing are carried out using a software program without effecting any improvisation, maximum backup may occur in the wireless send queue to give rise to a long delay time even at an input load within a “certain range” that is considerably below the system's maximum throughput point.

More specifically, as shown in FIG. 17, delay becomes large even in a certain fairly low LAN input load range 11 (17.2) and since the delay within this range is one occurring in a range in which the system ensures data transmission, everything possible must be done to restrain it.

As explained earlier, delay caused by backup in a queue is delay occurring on the wireless send queue (14.1) side. The wireless send queue is therefore shown again at (15.1) in FIG. 15 for use in explaining a commonly adopted software processing configuration.

Data blocks to be transmitted over the wireless field on Dchs (Dch data blocks (15.2)) are entered in the wireless send queue (15.1) as queue members. The Dch data blocks (15.2) ordinarily consist of a plurality of linked LAN frames (15.3).

In FIG. 15:

Lin (15.4) represents LAN frame input.

Win (15.5) represents enqueuing to the wireless send queue.

Wout (15.6) represents dequeuing from the wireless send queue.

The link/enqueue task (15.7) consists of linking and loading multiple LAN frames input from the system in a single Dch data block and enqueuing (Win (15.5)) the Dch data block in the wireless send queue (15.1). The link/enqueue task will sometimes be referred to simply as “task” hereinafter.

As shown in FIG. 15, the software module for performing this task (task module) is periodically activated. The LAN frames input (Lin (15.4)) during each period are linked in a single Dch data block (15.2) and, when an enqueue condition is met, the Dch data block (15.2) is enqueued (Win (15.5)).

There are two enqueue (Win (15.5)) conditions:

(1) The empty region of the Dch data block (i.e., the empty region of the transmission slot) is too small to permit linked loading of a newly input (LIN (15.4)) LAN frame in the same Dch.

(2) No newly input (Lin (15.4)) LAN frame exists.

When condition (2) holds or at the time point when the number of input LAN frames reaches a (predefined) upper limit number, the task enqueues (Win (15.5)) the current Dch data block in the wireless send queue and the processing is terminated.

FIG. 16 shows the wireless transmission system processing cycle, where:

T_Lin (16.1) represents the average LAN frame input period.

T_Win (16.2) represents the average period of enqueuing to the wireless send queue.

T_Wout (16.3) represents the average period of dequeuing from the wireless send queue.

T__Task (16.4) represents the average period between activations of the link/enqueue task.

Generally, therefore, the task cycle (T_Task (16.4)) tends to grow longer with increasing LAN frame input load.

When the LAN frame input load is quite low, the task cycle (T_Task (16.4)) is shorter than the Wout cycle (T_Wout (16.3)). When the LAN frame input load exceeds a certain level, however, it is safe to assume that the task cycle (Task 16.4)) is longer than the Wout cycle (T_Wout (16.3)).

A wireless transmission driver (15.8) operates to extract the Dch data blocks (queue members) entered in the wireless send queue (15.1) and load them in Dchs (Wout (15.6)).

Since the wireless transmission driver (15.8) creates Dchs synchronously with the periodically occurring Wout (15.6), it performs interrupt processing activated by the Wout cycle (T_Wout (16.3)). In other words, the Wout cycle (T_Wout) is also the wireless transmission driver activation cycle.

The conditions for occurrence of the regions I-IV in FIG. 17 are as follows:

(1) T_Wout<T_Link (i.e., Wout rate>Lin rate); I region (17.1)).

As shown in FIG. 18, since the LAN input load is smaller than the wireless speed (Wout rate) in this region, backup in wireless send queue is quite small and almost no delay arises.

(2) TWout>T_Lin (i.e., Wout rate<Lin rate);

(2) −1: Number of links per task (T_Task/T_LIN) <maximum number of links (joint_max);

(2)−1.1: T_Wout<T_Task; II region (17.2).

At this time, as shown in FIG. 19, “Wout rate<Win rate,” the backup at the wireless send queue becomes maximum, and the maximum delay time arises.

(2) −1.2: T_Wout<T_Task; III region (17.3).

At this time, as shown in FIG. 20, “Wout rate<Win rate,” the backup at the wireless send queue becomes quite small, and almost no delay arises.

(2) −2.1: Number of links per task (T_Task/T_LIN) >maximum number of links; IV region (17.4).

From here onward, as shown in FIG. 21, “Wout rate<Win rate” constantly, the backup at the wireless send queue becomes maximum, and the maximum delay time arises (the system enters a congested state in which the upper limit of its transmission processing capability is exceeded).

What causes a problem here is the occurrence of maximum delay time in the II region. (17.2). In the II region (17.2), the task period T_Task is shorter than the dequeue period T_Wout. When Win is performed after every task, therefore, the Win rate exceeds the Wout rate and, as a result, maximum backup occurs at the wireless send queue and a large delay time arises.

The present invention was accomplished in light of the foregoing circumstances and has as an object to enable wireless transmission of fixed-length data transmission channels carrying multiple transmission data frames (slots) and to reduce backup in the wireless send queue and delay caused thereby so as to achieve efficient data transmission for ensuring effective utilization of the wireless transmission medium. Other objects and the present invention will become apparent from the following explanation.

### SUMMARY OF THE INVENTION

In order to hold down delay in the II region (17.2), it is necessary to avoid performing Win unconditionally following completion of every linking task.

This will be explained concretely with reference to FIG. 22. Defining time elapsed since the task module performed enqueue (Win) in the preceding cycle as ΔT (22.1), when the number of linked LAN frames at completion of task processing has not yet reached maximum, Win must not be performed so long as the condition ΔT<T_Wout holds. This is because if Win is performed when this condition hold, the state of T_Win<T_Wout is established, i.e., Win rate comes to exceed Wout rate so that maximum backup occurs in the wireless send queue to produce a large delay time.

One basic concept of the present invention is therefore is to impart appropriate control to the wireless send queue enqueue processing (Win) for adjusting the timing of enqueue (Win) so that backup does not occur and thereby control delay in the II region (17.2) as well as other regions.

In a first aspect, the present invention provides a wireless transmission system for conducting data transmission over a wireless field in which data transmission slots of a fixed size are periodically allocated to the wireless field, which wireless transmission system comprises a memory for retaining a wireless send queue whose members are transmission data awaiting transmission, linking means for linking multiple transmission data to form members of the wireless send queue, wireless send means for loading a wireless send queue member output from the memory in a data transmission slot, and control means responsive to output of a wireless send queue member from the memory for controlling retention of a next wireless send queue member in the memory.

Therefore, since the enqueuing (Win) of a wireless send queue member is timed in response to the dequeuing (Wout) of a wireless send queue member, occurrence of delay during linking and loading can be restrained while also achieving effective utilization of slot (channel) capacity by linking and loading multiple transmission data in the wirelessly transmitted data transmission slots.

In the wireless transmission system of the present invention, the control means preferably monitors the number of wireless send queue members retained in the memory and effects control for retaining the next wireless send queue member in the memory when no wireless send queue member is retained or the number of retained wireless send queue members is smaller than at the time of the preceding memory output.

In the wireless transmission system of the present invention, the control means further preferably effects control for retaining the next wireless send queue member in the memory synchronously with output of a wireless send queue member from the memory.

In a second aspect, the present invention provides a wireless transmission system for conducting data transmission over a wireless field in which data transmission slots of a fixed size are periodically allocated to the wireless field, which wireless transmission system comprises a memory for retaining a wireless send queue whose members are transmission data awaiting transmission, linking means for successively linking and inserting multiple transmission data in the members of the wireless send queue retained in the memory, wireless send means for loading a wireless send queue member output from the memory in a data transmission slot, and control means, responsive to output from the memory of a wireless send queue member under link/insertion processing or to a condition in which loading of next transmission data in a wireless send queue member under link/insertion processing would make its size larger than the data transmission slot for shifting the processing of the linking means to processing, for linking and inserting transmission data in the next wireless send queue retained in the memory.

Therefore, by carrying out link processing of the transmission data directly with respect to the wireless send queue members retained in the memory, backup in the queue can be reduced and the link processing can be shifted to the next queue member with appropriate timing.

More specifically, in the wireless transmission system according to this aspect of the present invention, the memory and control means are constituted as a physical module connected to an internal bus, thereby reducing the software processing load. The module is provided with a bus interface for forwarding a wireless send queue member output from the memory to the wireless send means and the control means compares the size of the empty region of the wireless send queue member under link/insertion processing with the size of the next transmission data to be linked and inserted and shifts the link/insertion processing to the next wireless send queue member.

Another object of the present invention is to achieve efficient data transmission for achieving effective utilization of the wireless transmission medium by enabling wireless transmission of multiple data frames loaded in a fixed-length data communications channel.

In order to achieve this object, the present invention provides a wireless transmission system for conducting wireless communication between a base station and at least one customer station using fixed-length data communications channels, the wireless transmission system comprising a buffer for retaining frames to be sent in at least one of the base station and the customer station, a comparing means for comparing the size of a frame to be sent retained in the buffer and the size of an empty region of the wireless send queue member, and loading means for loading a lodable number of frames to be sent in the same data communications channel.

Since the customer station (or base station) therefore wirelessly transmits data communications channels carrying multiple frames, the capacity of the data communications channels can be effectively utilized.

As the present invention provides a wireless transmission system constituted as a customer station and/or base station incorporating the aforesaid capabilities, it makes possible a wireless transmission system that can effectively utilize the wireless transmission medium.

Since the present invention loads multiple frames to be sent in a single data communications channel together with intervening data for indicating their boundaries, the receiving side can easily identify and receive-process the frames loaded in the data communications channel.

### BRIEF EXPLANATION OF THE DRAWINGS

FIG. 1 is a diagram showing an example of a wireless communication system to which the present invention applies.

FIG. 2 is a diagram showing a wireless transmission system according to an embodiment of the present invention.

FIG. 3 is a flow chart for explaining a first mode according to the present invention.

FIG. 4 is a diagram for explaining a second mode according to the present invention.

FIG. 5 is a diagram for explaining a third mode according to the present invention.

FIG. 6 is a diagram for explaining a fourth mode according the present invention.

FIG. 7 is a diagram for explaining a fifth mode according the present invention.

FIG. 8 is a diagram for explaining a delay measurement equipment setup in an embodiment of the present invention.

FIG. 9 is a diagram showing measurement results in the case of not conducting enqueue control in an embodiment of the present invention.

FIG. 10 is a diagram showing measurement results in the case of conducting enqueue control in an embodiment of the present invention.

FIG. 11 is a diagram for explaining an empty region occurring in a Dch.

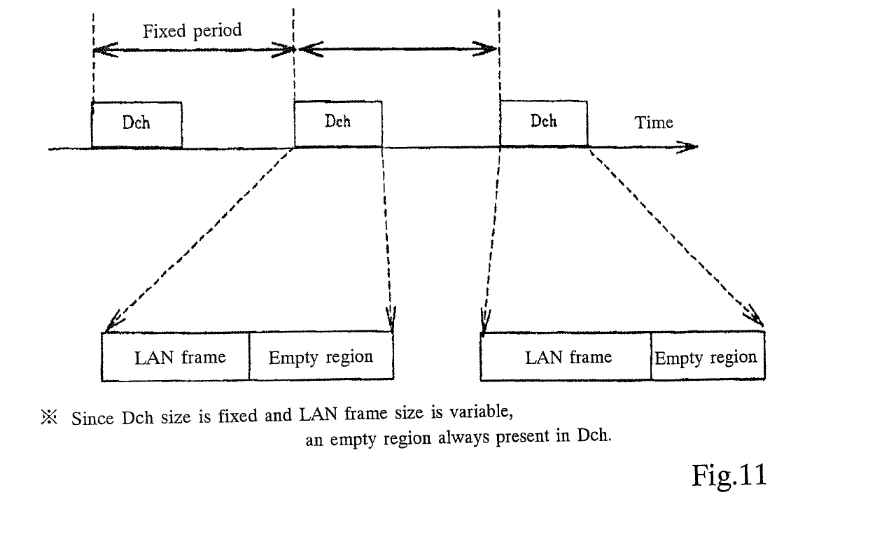

FIG. 12 is a diagram showing a delay time profile occurring in a queue according to queuing theory.

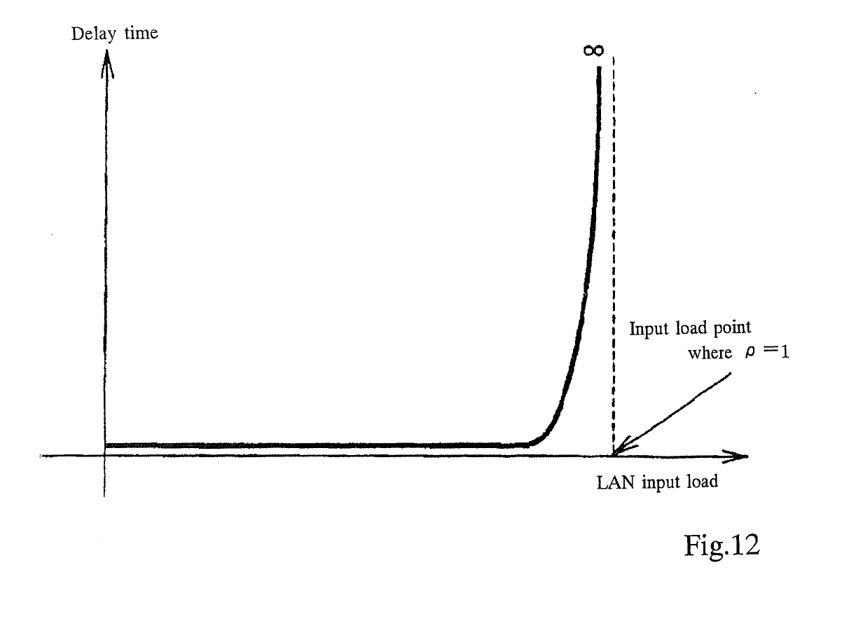

FIG. 13 is a diagram showing a delay time profile occurring in actual practice.

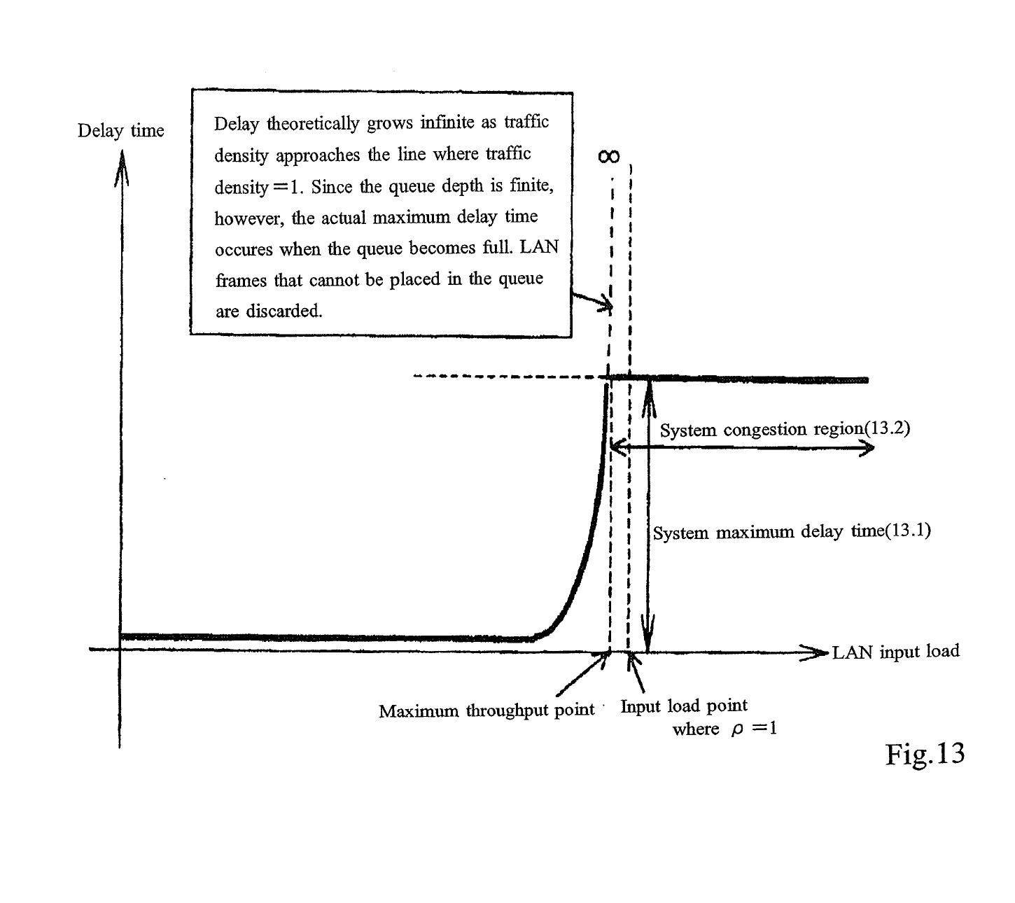

FIG. 14 is a diagram for explaining queues in a wireless transmission system.

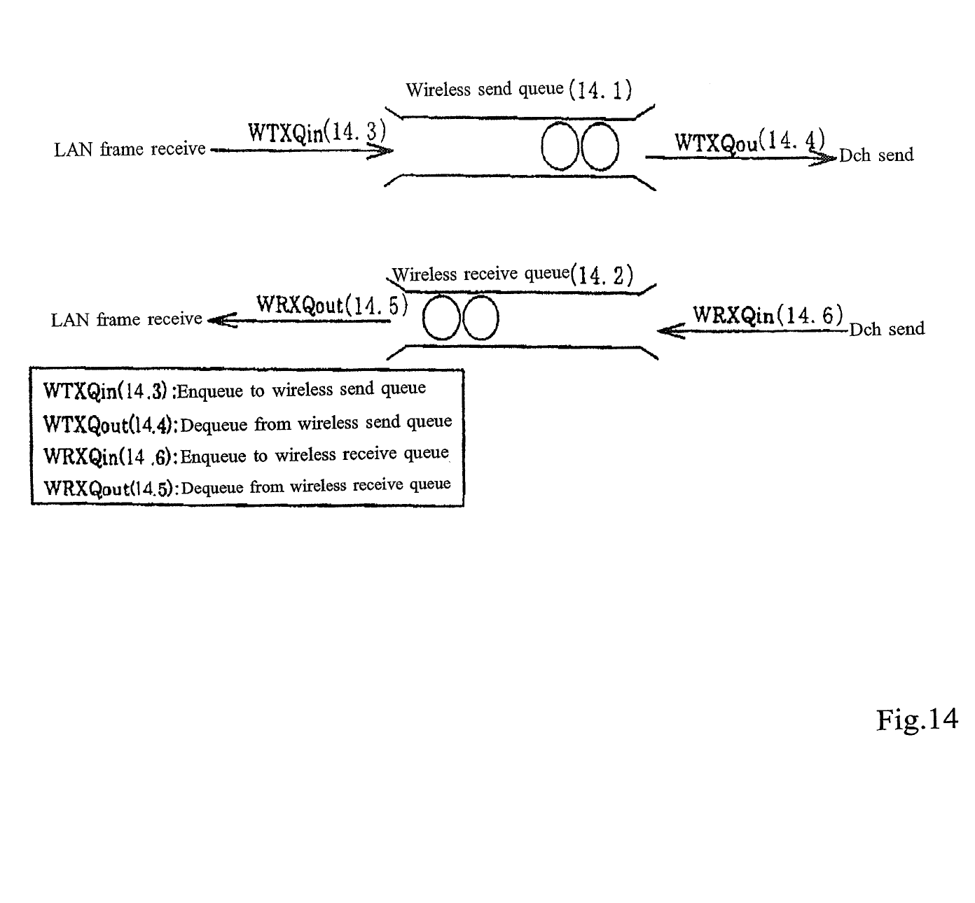

FIG. 15 is a diagram for explaining LAN frame linking and enqueuing to a wireless send queue.

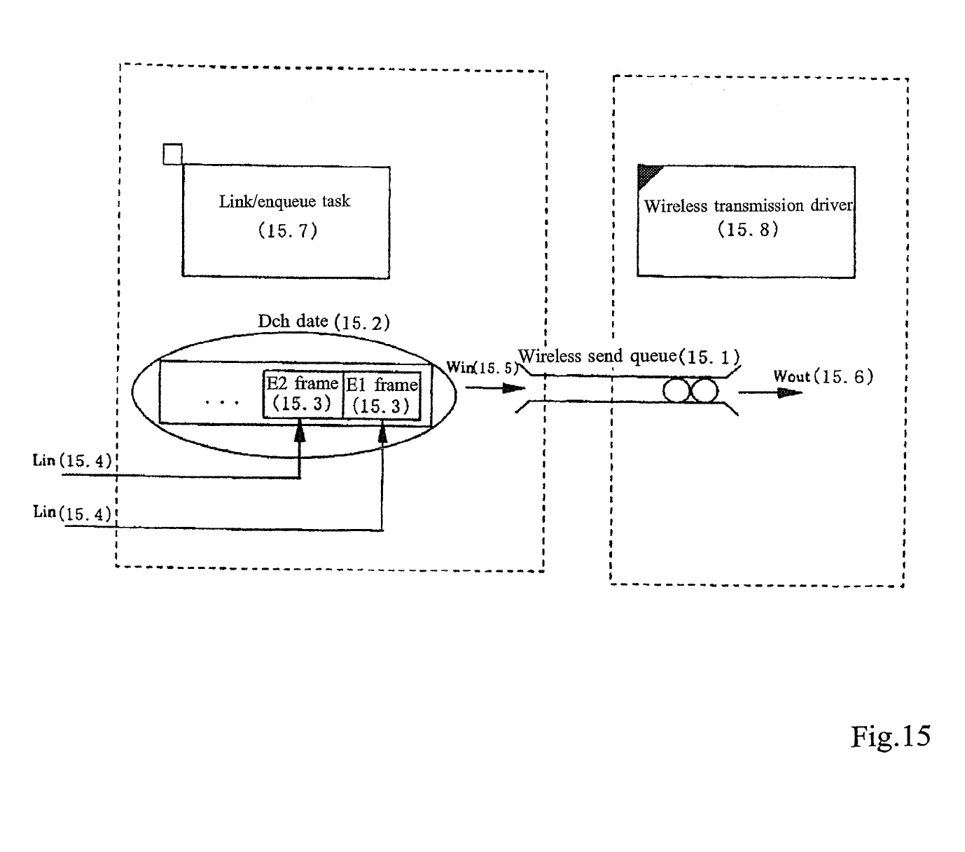

FIG. 16 is a diagram for explaining processing periods in a wireless transmission system.

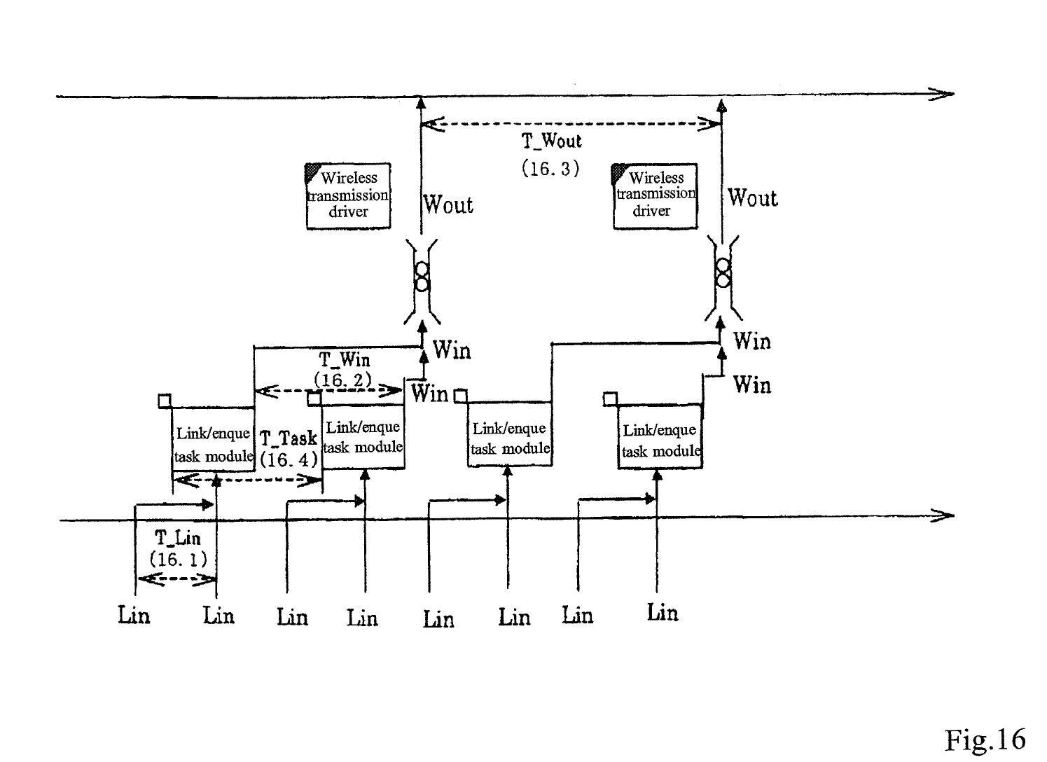

FIG. 17 is a diagram showing a delay time profile occurring in a queue in a wireless transmission system.

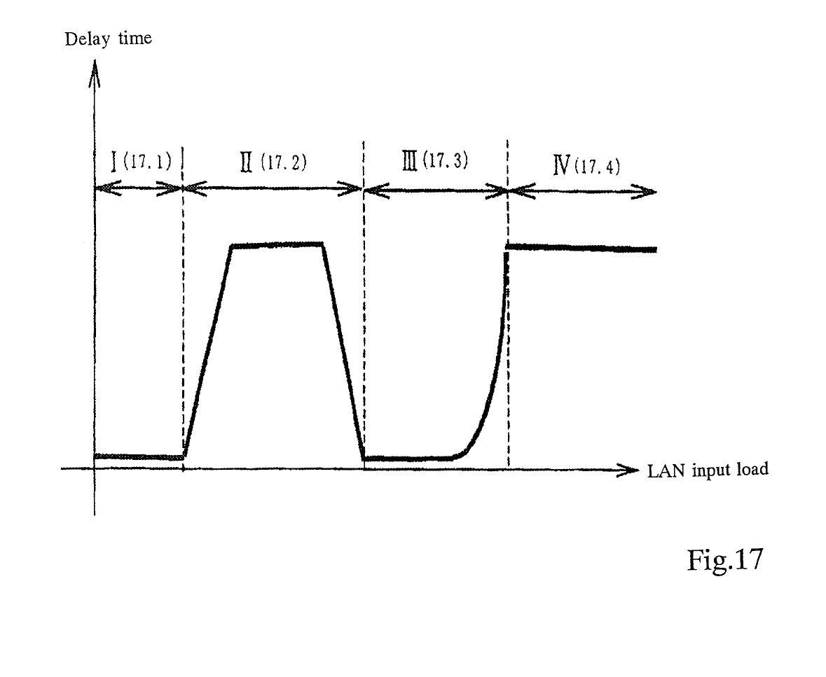

FIG. 18 is a diagram for explaining the processing state corresponding to (17.1) in FIG. 17.

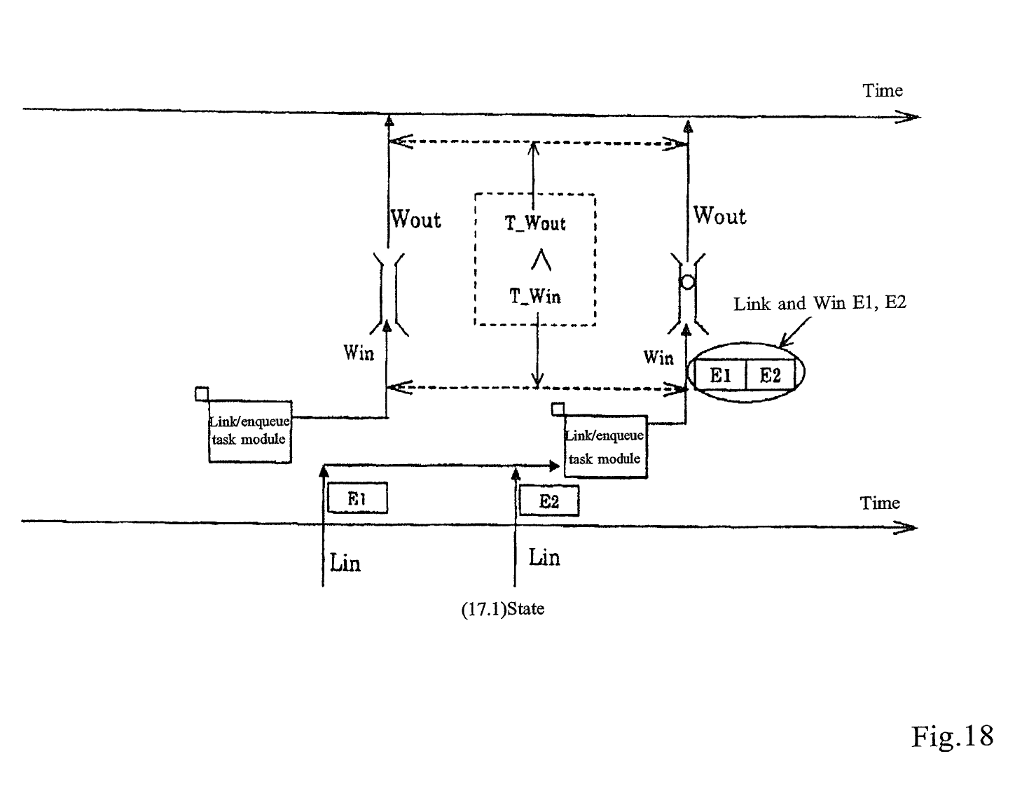

FIG. 19 is a diagram for explaining the processing state corresponding to (17.2) in FIG. 17.

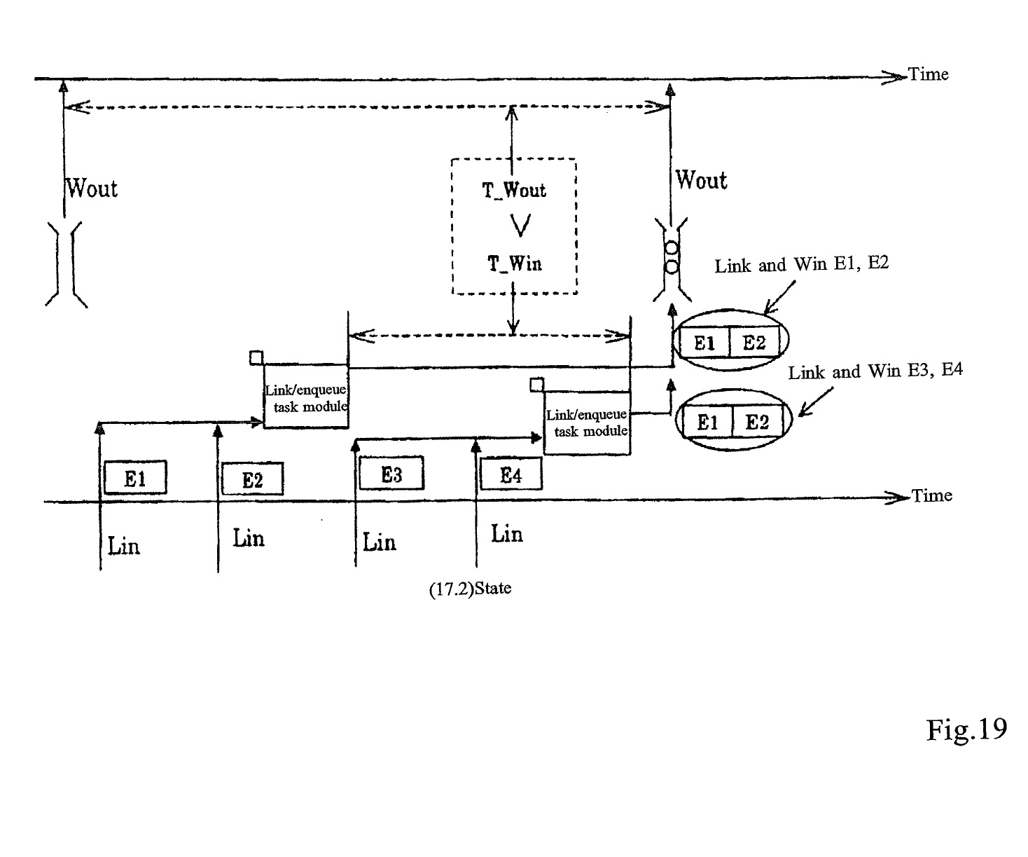

FIG. 20 is a diagram for explaining the processing state corresponding to (17.3) in FIG. 17.

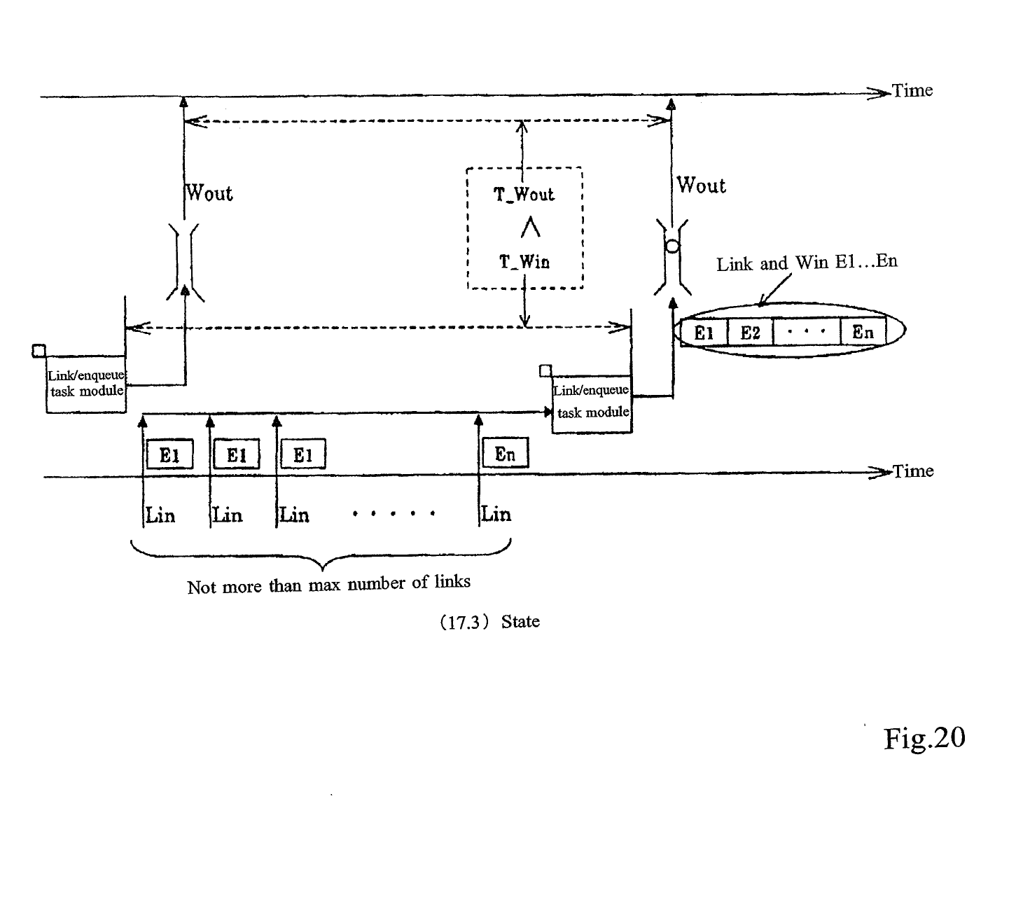

FIG. 21 is a diagram for explaining the processing state corresponding to (17.4) in FIG. 17.

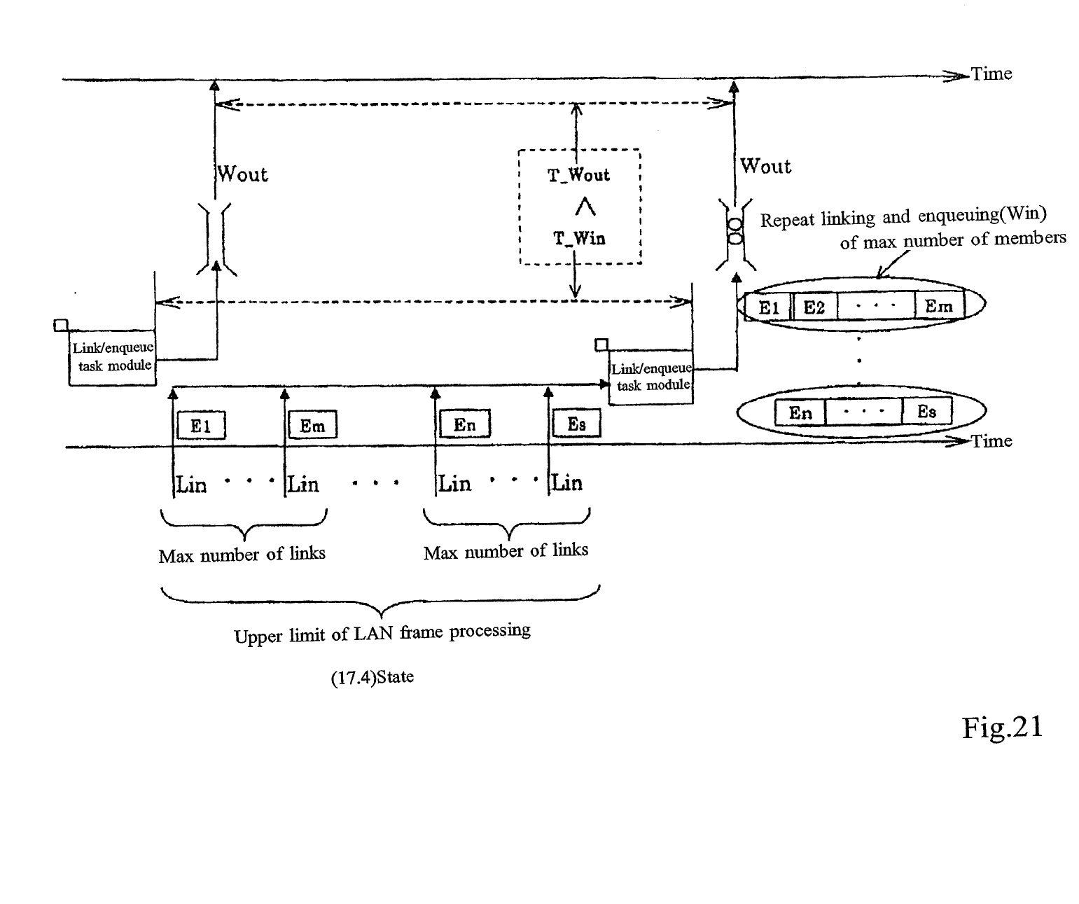

FIG. 22 is a diagram for explaining conditions for restraining delay in the state corresponding to (17.2) in FIG. 17.

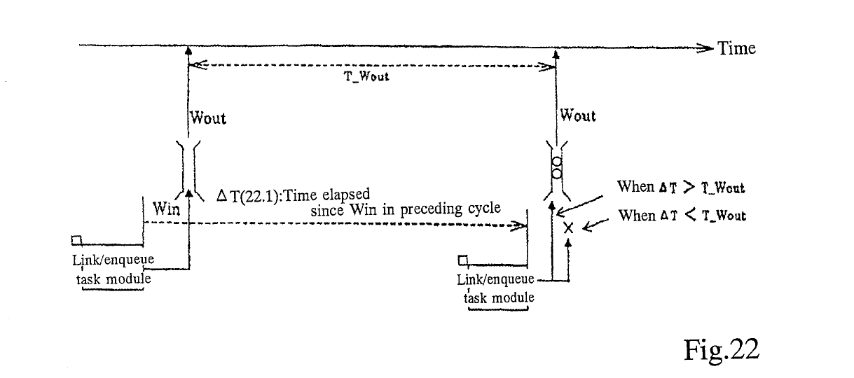

FIG. 23 is a block diagram of the essential components of a customer station according to another embodiment of the present invention.

FIG. 24 is a diagram showing a wireless frame format according to another embodiment of the present invention.

FIG. 25 is data communications channel format according to another embodiment of the present invention.

FIG. 26 is a flow chart showing the sequence of send procedures according to another embodiment of the present invention.

FIG. 27 is a diagram showing the loaded state of a data frame to be sent according to another embodiment of the present invention.

### DESCRIPTION OF THE PREFERRED EMBODIMENTS

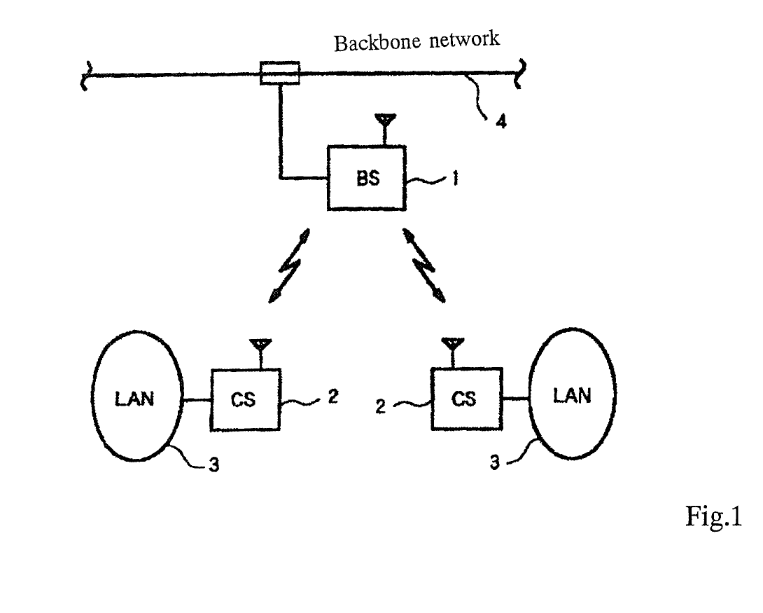

The present invention will now be explicitly explained taking as an example a P-MP (point-to-multipoint) system in which, as shown in FIG. 1, multiple CSs (customer stations) 2 are wirelessly linked with a single BS (base station) 1.

Although the BS 1 and the CSs 2 are both encompassed by the wireless transmission system of the present invention, the following explanation will focus chiefly on the BS 1.

Each CS 2 is capable of receiving LAN frames (transmission data) from its LAN 3 side and transmitting them over a wireless field to the BS 1. It is also capable of extracting LAN frames from Dchs (transmission slots) received from the BS 1 over the wireless field and transferring them to its LAN 3 side.

The BS1 is capable of receiving LAN frames from its LAN 4 side and transmitting them over the wireless field to a specific CS 2. It is also capable of extracting LAN frames from Dchs received from a CS2 and transferring them to its LAN 4 side.

Transmission from the BS to a CS is called downloading and transmission from a CS to the BS is called uploading. In this embodiment, the link processing during uploading is the same as the link processing for downloading except that it does not include the control for restraining delay explained later. The processing during downloading will therefore be explained in the following, i.e., the processing conducted when the BS 1 transmits data over the wireless field will be explained.

When the LAN frame that the BS 1 receives from the LAN 4 side is a multicast frame, the BS 1 transmits it to all CSs 2. When the LAN frame received from the LAN 4 side is a unicast frame, the BS 1 first determines the destination CS 2 and submits it to that CS 2.

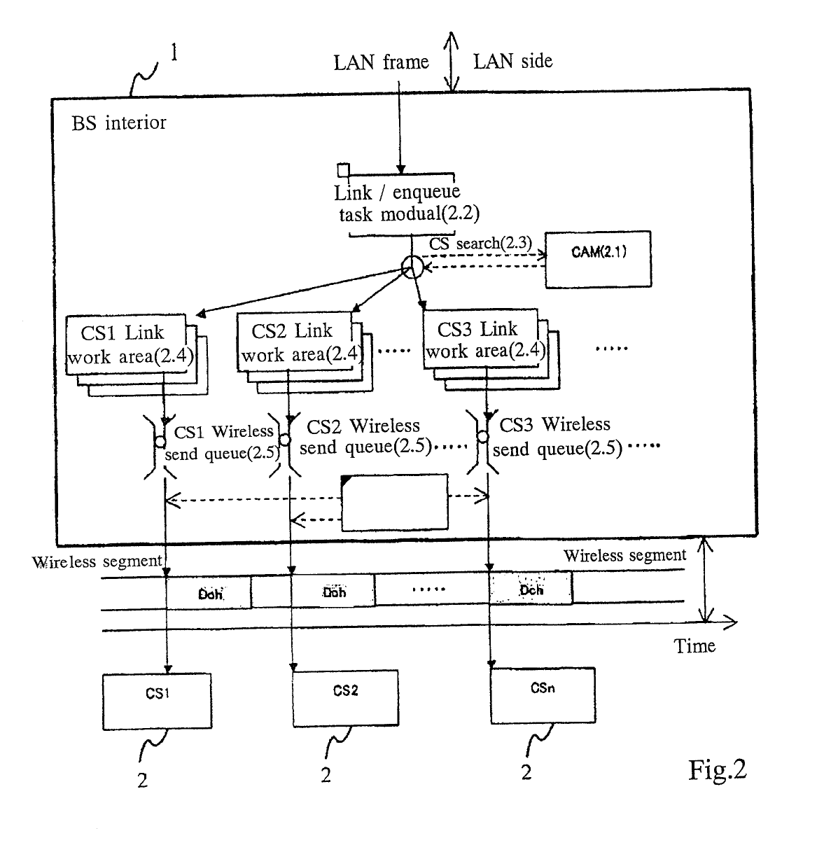

As shown in FIG. 2, the BS 1 is equipped with an internal CAM (content address memory) (2.1). It checks the CAM (2.1) to determine the destination CS 1.

The CAM (2.1) is a device capable of recording a plurality of sets each composed of “a MAC (medium access control) address and a CS number.” It is an associative memory device that when input with a MAC address as an input value can output the corresponding CS address as an output value.

During downloading, when the destination MAC address of a LAN frame is input to the CAM (2.1) and a CS number corresponding to the MAC address exists, the CAM (2.1) outputs the CS number. When a corresponding MAC address does not exist, the CAM (2.1) outputs a value indicating that no corresponding MAC address exists. In order for the CAM (2.1) to output a valid CS number, therefore, the CS number must first be recorded therein.

Although not shown in FIG. 2, a wireless receive driver and a wireless receive task module are invoked in the BS 1 during uploading.

The wireless receive driver receives upload requests from the CSs 2, allocates transmission bands (Dchs) to the CSs 2, and actually receives the Dchs. The wireless receive task module receives from the wireless receive driver the Dch data blocks loaded into Dchs and transmitted from the CSs, and also the sender CS numbers, extracts the LAN frames loaded inside the Dch data blocks, and transfers them to the LAN 4 side.

When the wireless receive task module extracts a LAN frame from a Dch data block, it records a set composed of the MAC address of the sender and the CS number of the sender in the CAM (2.1). By using the destination MAC address of the extracted LAN frame to search the CAM (2.1), the wireless receive task module can implement transmission back and forth between two different CSs.

Thus, as regards a once uploaded LAN frame, the BS 1 can, when it receives a LAN frame pointed in the opposite direction, identify the destination CS 2 from the CAM (2.1).

As regards a LAN frame that has never been uploaded, the BS 1 cannot discriminate the CS 2 to which a LAN frame pointed in the opposite direction should be sent. In such a case, either (1) the received LAN frame is sent to all CSs or (2) the received LAN frame is discarded.

In an ordinary bridge, a LAN frame whose destination is unknown is handled by method (1) (called “flooding” ). In the case of a wireless transmission system, however, in light of the need to effectively utilize the wireless band used in common throughout the system, the latter method (2) is also an option worth considering.

In actual communication via LANs, since a multicast always occurs at the very first stage of the communication and a unicast is produced in response to the multicast (a unicast frame is not produced from the start in the download direction), adoption of method (2) does not cause a substantial problem.

Such being the basic processing, a link/enqueue task module (2.2) of the BS 1 is invoked during downloading to conduct linking for each destination CS 2.

When multiple CSs 2 are wirelessly connected with the BS1, the flow of the link processing in the BS 1 is as follows:

(1) When the BS 1 receives a unicast LAN frame from its LAN 4, the link/enqueue task module (2.2) utilizes a CAM search function (2.3) to search the CAM (2.1) and determine the destination.

(2) In the BS 1 memory, multiple link work areas (2.4) are allocated for each CS 2. After the destination CS 2 has been determined, the received LAN frame is transferred to a link work area (2.4) for that CS 2.

(3) When LAN frames directed to the same CS are received consecutively, they are transferred to the same link work area (2.4) and linked.

The transfer/link processing at the individual link work areas (2.4) proceeds as follows:

The first LAN frame is stored in the link work area (2.4). Next, the size of the second LAN frame is compared with the size of the empty region that will remain in a data transmission slot (Dch) after the first LAN frame is loaded in it. When the size of the empty region is large enough to hold the second frame, the second frame is stored in the same link work area (2.4) as the first frame with a delimiter bit inserted between the two frames.

Then the size of the third frame is compared with the size of the empty region that will remain in the data transmission slot after the first and second frames are loaded in it. When the size of the empty region is large enough to hold the third frame, the third frame is stored in the same link work area (2.4) as the first and second frames with a delimiter bit inserted between the second frame and the third frame.

Thereafter, each successive frame is stored in the same link work area (2.4) so long as the size of the empty space that will remain in the fixed-length data transmission slot is big enough to hold it. Multiple frames directed to the same CS are thus stored in the link work area (2.4).

When a multicast LAN frame is received, or when a unicast LAN frame whose destination cannot be determined is to be flooded, the LAN frame is transferred to and linked at the link work area (2.4) for every CS.

(4) When the link work area (2.4) for a CS no longer has enough empty space to permit linking of the next received LAN frame directed to the same CS, the linked data in the region is enqueued in an associated wireless send queue (2.5). The received LAN frame that could not be stored is transferred to another link work area (2.4) for the same CS.

(5) The data enqueued in the customer station wireless send queue (2.5) (the queue members) are loaded in a Dch (data transmission slot) and sent to the CS by a wireless send driver (2.6). Dchs are allocated to the wireless field for the every CS.

(6) When there are no more LAN frames or the number of LAN frames processed has reached the upper limit, the processing by the link/enqueue task module (2.2) is terminated.

In the enqueue and dequeue processing at the wireless send queue (2.5), the BS 1 of this embodiment conducts control processing for backup restraint in one of modes 1 to 4 explained below.

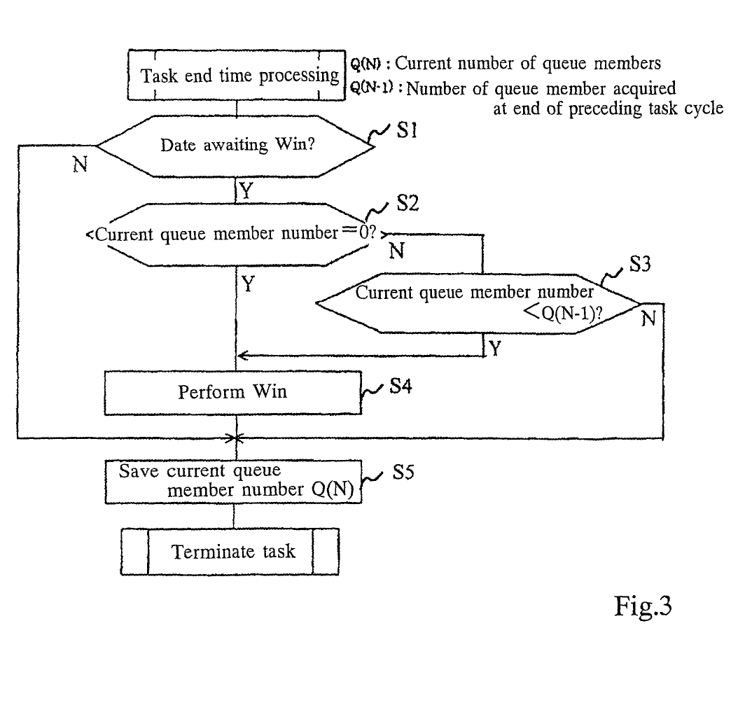

As shown in FIG. 3, mode 1 uses a queue monitoring method.

The number of queue members in the wireless send queue decreases by one with each dequeue (Wout). The interval during which the number of queue members is decremented by 1 (−1) is therefore T_Wout.

If at processing completion LAN frames fewer than the maximum linkable number are waiting to be enqueued (Win) (step S1), the task module (2.2) checks the current number of queue members Q (N), and if the current number of queue members is 0 (step S2) or if a comparison of the current number of queue members Q (N) and the number of queue members Q (N−1) stored at completion of task processing in the preceding cycle shows that the condition (current number of queue members)<(number of queue members in preceding cycle) holds (step S3), the task module (2.2) enqueues (Win) the next queue member in the wireless send queue (step S4), stores the current number of queue members, and terminates the task.

On the other hand, when the foregoing conditions (steps S1, S3) do not hold, the task module saves the current number of queue members without enqueuing (Win), terminates the task (step S5), and enters a standby state.

As will be understood from the foregoing, when one or more input LAN frames are present at the time of the next task processing, the link processing is conducted in the manner of adding to the current linked data.

Thus, the task module (2.2), by self-regulation, monitors the number (or change in the number) of queue members in the wireless send queue and, as a result, enqueues the next queue member in the wireless send queue in response to dequeuing of a queue member. This prevents a situation from arising in which queue members back up in the wireless send queue, and thus prevents occurrence of delay, particularly in the II region (17.2).

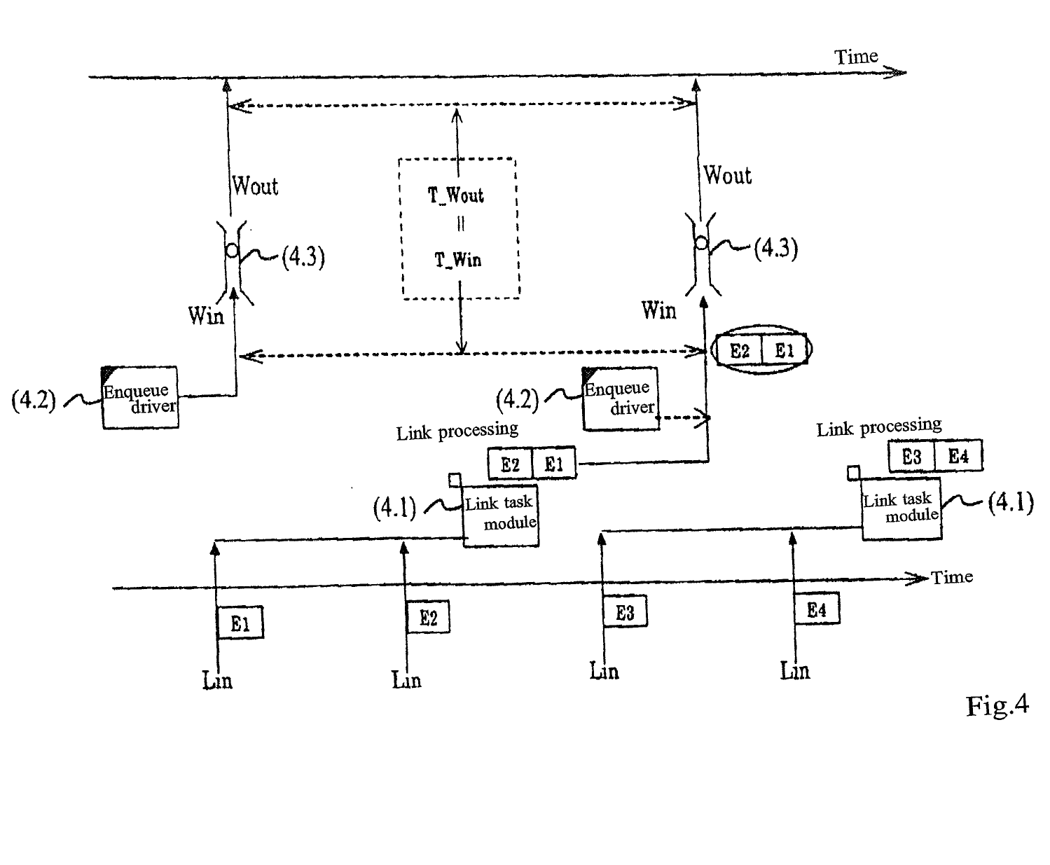

Mode 2, which differs from the foregoing mode, will now be explained. As shown in FIG. 4, in mode 2 the enqueue processing (Win) is performed as interrupt processing.

The configuration for implementing mode 2 is divided into a link task module (4.1) for link processing and an enqueue driver (4.2) for performing enqueue (Win) to a wireless send queue (4.3).

The link task module (4.1) is activated periodically. It conducts processing for linking LAN frames in each task cycle. The link task module (4.1) executes Win only when the current link processing has reached the maximum linkable number and does not perform Win at any other time.

The enqueue driver (4.2) is activated to conduct interrupt processing once every T_Wout. In each interrupt processing cycle activated synchronously with dequeuing, the linked data linked by the link task module (4.1) are enqueued (Win) and the processing is terminated.

The enqueue driver (4.2) uses a flag that both it and the link task module (4.1) can check to notify the link task module (4.1) that it dequeued (Wout) the linked data and the link task module (4.1) terminates the link processing on receipt of this notice.

Thus, the enqueue driver (4.2), by self-regulation, enqueues the next queue member in the wireless send queue synchronously with dequeuing. Therefore, particularly in the II region (17.2), enqueuing (Win) at a shorter cycle than T_Wout is prevented to preclude a situation from arising in which queue members back up in the wireless send queue. As a result, occurrence of delay can be avoided.

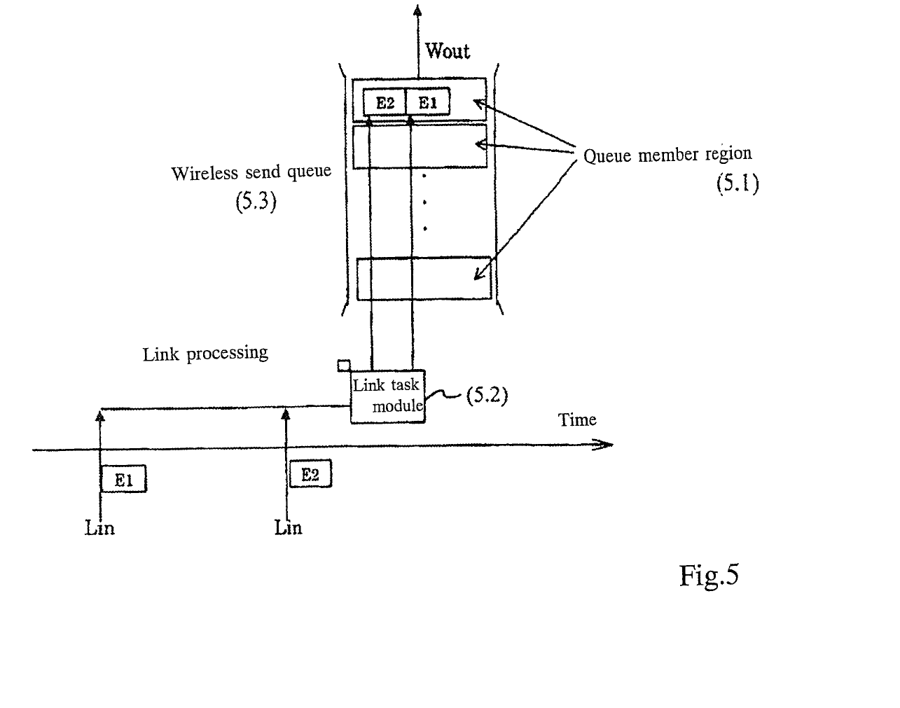

Mode 3, which differs from the foregoing modes, will now be explained. As shown in FIG. 5, in mode 3 a link task module (5.2) directly conducts link processing with respect to to the individual queue member regions (5.1) of a wireless send queue (5.3).

Upon dequeuing (Wout) of the current (leading) queue member, or when it has become impossible to link any more data in the current queue member region, the link task module (5.2) shifts to the next queue member region and links data there.

Each queue member region (5.1) is provided with a dedicated flag that can be checked both by task module (5.2) and a wireless transmission driver (not shown), and at the time of performing a Wout the wireless transmission driver uses the corresponding flag to notify the link task module (5.2) that it dequeued (Wout) the queue member. Upon receiving this notice, the link task module (5.2) recognizes that the link processing with respect to the queue member has been terminated.

Thus, the link task module (5.2), by self-regulated processing, continues link processing with respect to a single queue member region (5.1) within the T_Wout time period, thereby producing and effect substantially equivalent to that of preventing an enqueue (Win) within a period shorter than T_Wout. This prevents a situation from arising in which queue members back up in the wireless send queue, and thus prevents occurrence of delay.

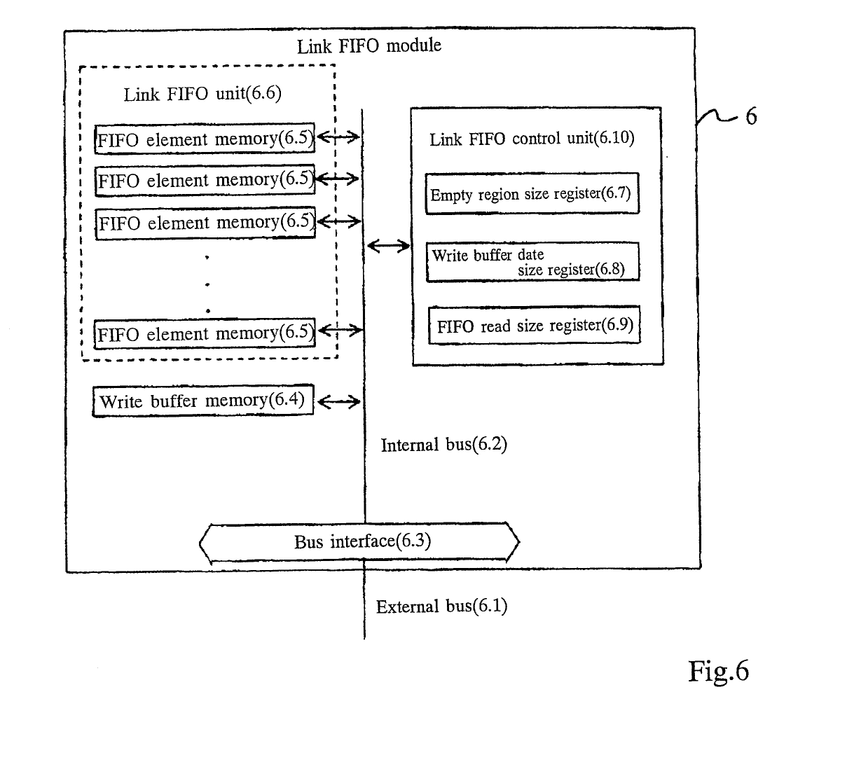

Mode 4 will now be explained. As shown in FIG. 6, mode 4 uses a single hardware module (a link FIFO (first-in-first-out) module 6) to implement the processing in mode 3 by which direct linking and loading are conducted with respect to the individual members of the wireless send queue.

The link FIFO module 6 comprises a bus interface (6.3) for interfacing between an external bus (6.1) accessible by a wireless transmission system control unit (CPU) and an internal bus (6.2) inside the link FIFO module 6, a write buffer memory (6.4) for writing in LAN frames through the external bus (6.1), and a link FIFO unit (6.6) including FIFO element memories (6.5).

The link FIFO module 6 further has an empty region size register (6.7) for storing the size of the empty region in the FIFO element memory (6.5) under link processing, a write buffer data size register (6.8) for storing the size of the LAN frame currently stored in the write buffer memory (6.4), and a FIFO read size register (6.9) for storing the read size when linked data stored in the link FIFO unit (6.6) through the external bus (6.1) are read. It is also equipped with a link FIFO control unit (6.10) for comparing the contents of the empty region size register (6.7) and the write buffer data size register (6.8) and transferring the received LAN frame in the write buffer memory (6.4) to an appropriate one of the FIFO element memories (6.5).

In the link FIFO module 6, a LAN frame written through the external bus (6.1) is first written in the write buffer memory (6.4) and at this time the link FIFO control unit (6.10) sets the size of the LAN frame in the write buffer memory (6.4) in the write buffer data size register (6.8). The link FIFO control unit (6.10) then compares the values of the write buffer data size register (6.8) and the empty region size register (6.7), whereafter it conducts one or the other of the following processing steps (1) and (2):

(1) When the received LAN frame size≦ the empty region size, the LAN frame stored in the write buffer memory (6.4) is, after being added with required header information and the like, transferred to the FIFO element memory (6.5) currently under link processing to be added as a link, whereafter the empty region size register (6.7) is updated.

(2) When the received LAN frame size> the empty region size, a new, currently unused FIFO element memory (6.5) is found and the LAN frame stored in the write buffer memory (6.4) is, after being added with required header information, transferred to the new FIFO element memory (6.5), whereafter the empty region size register (6.7) is updated. LAN frame frames written in thereafter are added as links to this next FIFO element memory.

The link FIFO control unit (6.10) next sets the FIFO element memory (6.5) that is to be read so as to be read out through the external bus (6.1) and, at the same time, sets the size of the linked data in the FIFO element memory (6.5) in the FIFO read size register (6.9) to enable reading via the external bus (6.1).

When the linked data have been read out through the external bus (6.1), the link FIFO control unit (6.10) restores the read-out FIFO element memory (6.5) to the unused state and simultaneously sets the next FIFO element memory (6.5) that is to be read so as to be read through the external bus (6.1) and sets the size of the linked data in that FIFO element memory in the FIFO read size register (6.9).

Since the link FIFO module 6 conducts link processing in the foregoing manner, the effect of the foregoing mode 3 can be obtained without use of software (a link task module).

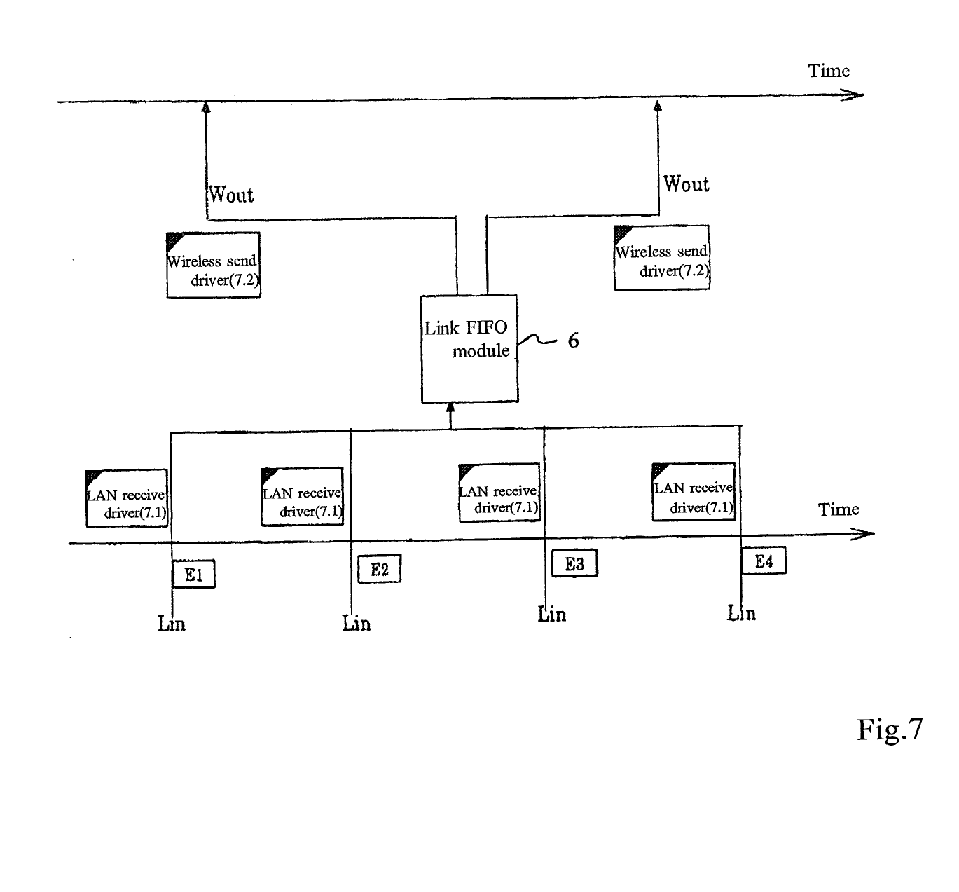

As shown in FIG. 7, for example, the link FIFO module 6 can operate in cooperation with a LAN receive driver (7.1) and a wireless send driver (7.2) to carry out the series of processing steps for linking received LAN frames and transmitting them over the wireless field, with the LAN receive driver (7.1) transferring a LAN frame to the link FIFO module 6 every time a LAN frame is received and the wireless send driver (7.2) extracting the linked data from the link FIFO module 6, loading them in Dchs and transmitting the Dchs over the wireless field.

Although the foregoing embodiments relate to a TDMA/TDD wireless transmission system, application of the present invention is not limited to this type of system. It can also be applied to an ordinary wireless transmission system in which multiple PDUs (protocol date units) linked to a host layer serve as a single SDU (service date unit) with respect to a subordinate layer for performing queuing to a transmission queue. In such an application, too, it is possible to achieve a reduction of the delay time arising in the queue by implementing the same control as in the foregoing embodiments.

The effect of the present invention will now be analyzed based on measurements made using an actual wireless transmission system.

The wireless transmission system used in the analysis conducted data transmission over the wireless field using TDMA/TDD. The depth of the wireless send queue was 128 (capable of holding 128 linked data members).

The wireless transmission system was used to compare the delay time between the case of (1) conducting enqueuing asynchronously to dequeuing and the case of (2) conducting enqueue control in the mode 1 (queue monitoring) explained in the foregoing.

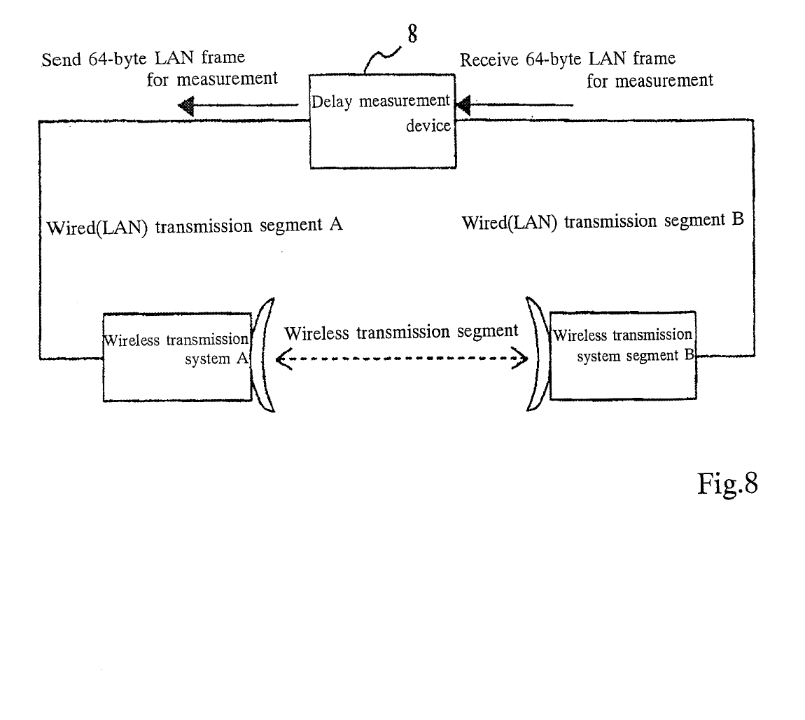

The equipment setup used for the measurements is shown in FIG. 8. A wireless transmission system A connected to a wired (LAN) transmission segment A and a wireless transmission system B connected to a wired (LAN) transmission segment B were used. LAN frames (transmission data) produced in the wired (LAN) transmission segment B were transmitted to the wired (LAN) transmission segment A through a delay measurement device 8 and the same LAN frames were wirelessly transmitted from the wireless transmission system A to the wireless transmission system B.

Only 64-byte LAN frames conforming with RFC1242/RFC25442 were produced for the measurement.

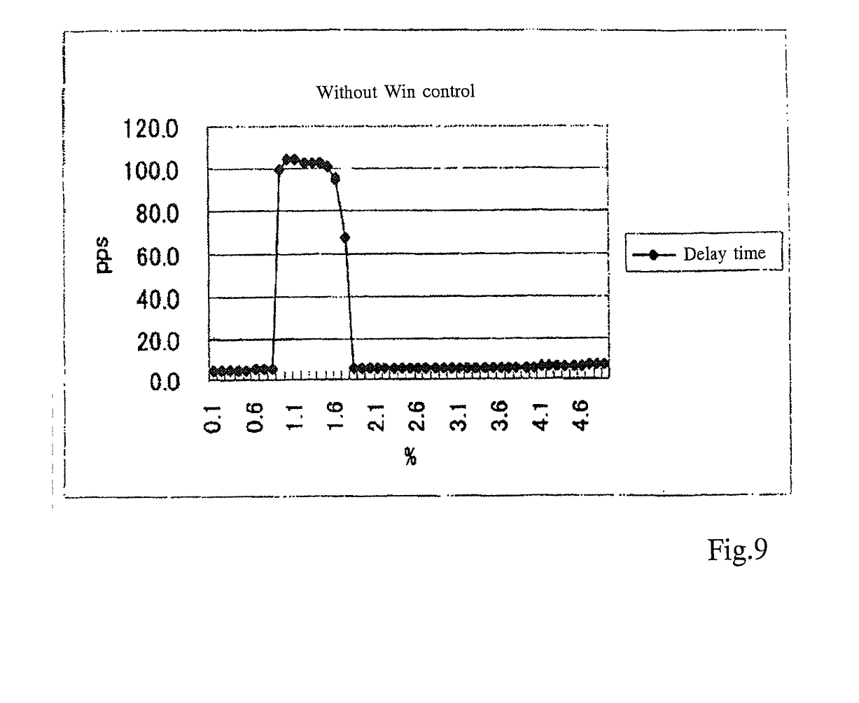

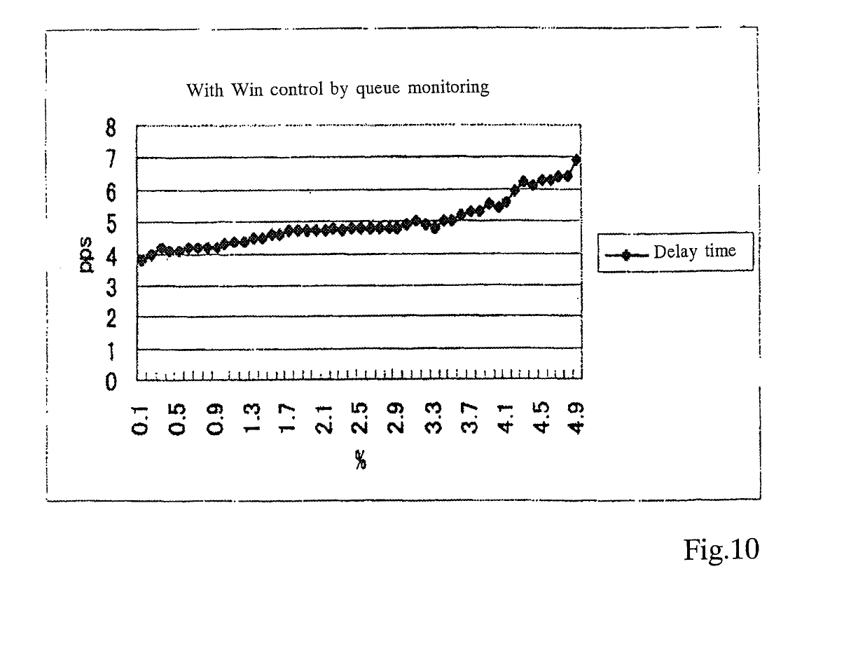

The delay time characteristic obtained when no enqueue control was conducted (case (1)) was as shown in FIG. 9. The delay time characteristic obtained when enqueue control was conducted (case (2)) was as shown in FIG. 10.

FIG. 9 shows that without control a delay time exceeding 100 millisecond arose at an input load from the LAN of 0.9-1.7%, while FIG.10 shows that with control the delay in the same range of FIG. 9 was completely restrained (delay time of less than 5 millisecond, 1/20 that without Win control). It was thus determined that the present invention produces a pronounced delay restraining effect.

As explained in the foregoing, in conducting the process of linking transmission data, loading the linked data in wireless field data transmission slots and wirelessly transmitting them, the present invention controls the enqueuing of the linked data in the wireless send queue awaiting transmission in response to the dequeuing from the wireless send queue. Backup in the wireless send queue and the delay caused by such backup are therefore reduced so as to achieve efficient data transmission that ensures effective utilization of the wireless transmission medium.

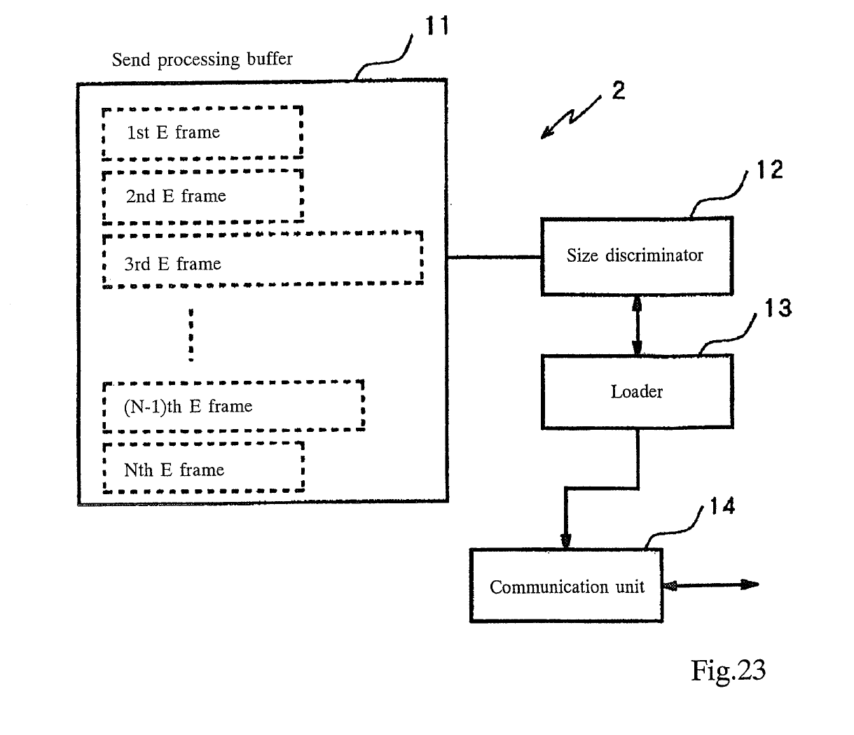

The wireless communication system according to the present invention will now be explained with reference to another embodiment. This embodiment, which is an application of the present invention to a subscriber wireless access system (particularly to its customer stations 2), will be explained with reference to FIGS. 1 and 23.

FIG. 23 is a block diagram of the essential components of a customer station 2 configured by application of the wireless transmission system of the present invention.

In addition to the functional units required by a conventional customer station for processing communication with a subscriber LAN 3 (FIG. 1) and wireless communication with the base station 1, the customer station 2 further comprises a send processing buffer 11 for storing in order of transmission a plurality of frames to be wirelessly sent by the customer station 2 to the base station 1, a size discriminator 12 for comparing and discriminating the size of the empty region of a fixed-length data communications channel allocated to the customer station 2 and the size of a frame waiting to be sent stored in the send processing buffer 11, and a loader 13 responsive to a finding that the fixed-length data communications channel has an empty region for accommodating the frame to be sent for loading the frame to be sent in the fixed-length data communications channel. These functional units carry out processing for loading a plurality of frames to be sent in a single data communications channel allocated to the customer station 2 and wirelessly transmitting the data communications channel from a communications unit 14.

In this embodiment, the frames to be wireless transmitted by the customer station 2 are variable length Ethernet and IEEE 802.3 data frames. In the drawings and the explanation to follow, the first frame in the order of sending is called the 1^{st} E frame, the second frame in the order of sending is called the 2^{nd} E frame, . . . and the N^{th} E frame in the sending order is called the N^{th} E frame.

An explanation will now be made regarding the TDMA/TDD wireless frame format used between the customer station 2 and the base station 1, and the data communications channel format included in the wireless frame format.

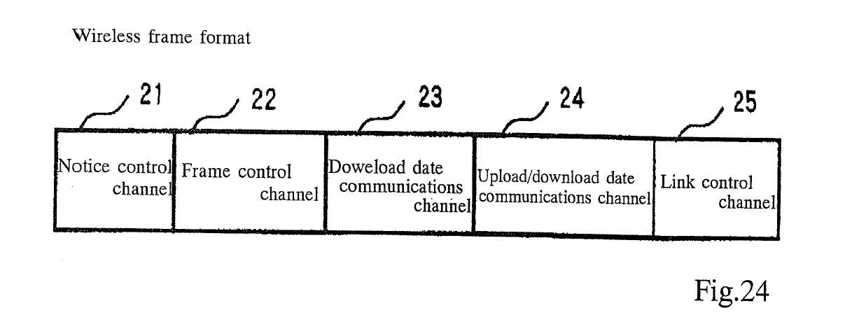

As shown in FIG. 24, the wireless frame format includes a notice control channel 21, frame control channel 22, download data communications channel 23, upload/download data communications channel 24, and link control channel 25.

The notice control channel 21 notifies all elements under the base station 1 of wireless frame synchronization timing, frame counter and base station identifier information, and data communications channel band allocation information.

The frame control channel 22 conducts notice of link control channel 25 band allocation information and notice of certification result information on the customer station at the base station and customer terminals thereunder.

The download data communications channel 23 sends Ethernet data frames from the base station to the customer station.

The upload/download data communications channel 24 sends Ethernet data frames from the base station to the customer station or from the customer station to the base station.

The link control channel 25 sends a request for allocation of a wireless band to the base station for using the upload/download data communications channel 24 for upload data transmission and sends a certification request from the customer station to the base station.

In other words, the data frames to be sent held in the buffer 11 of the customer station 2 are loaded in the upload/download data communications channel 24 and wirelessly transmitted to the base station 1.

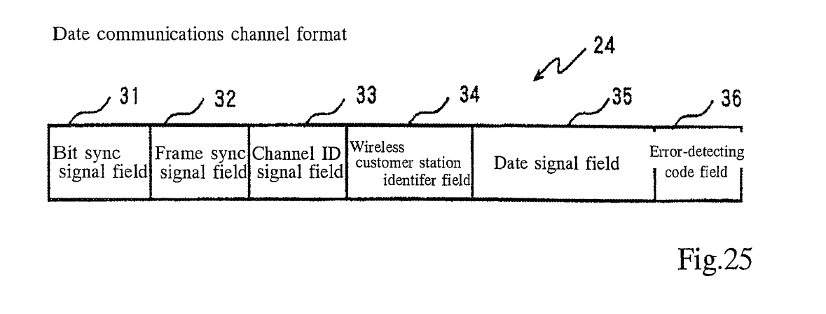

The upload/download data communications channel 24 included in the wireless frame format is of fixed length. As shown in FIG. 25, the data communications channel format includes a bit sync signal field 31 for establishing bit synchronization, a frame sync signal field 32 for establishing frame synchronization, a channel ID signal field 33 for identifying the channel, a wireless customer station identifier field 34 for identifying the allocated customer station, a data signal field 35 for carrying the data frames wirelessly transmitted by the customer station, and a error-detecting code field 36 for detecting error.

In other words, the data frames to be sent held in the buffer 11 (1^{St} E frame, 2^{nd} E frame, . . . and N^{th} E frame are loaded in the fixed-length data signal field 35 and wirelessly transmitted.

The send processing according to the foregoing configuration will now be explained.

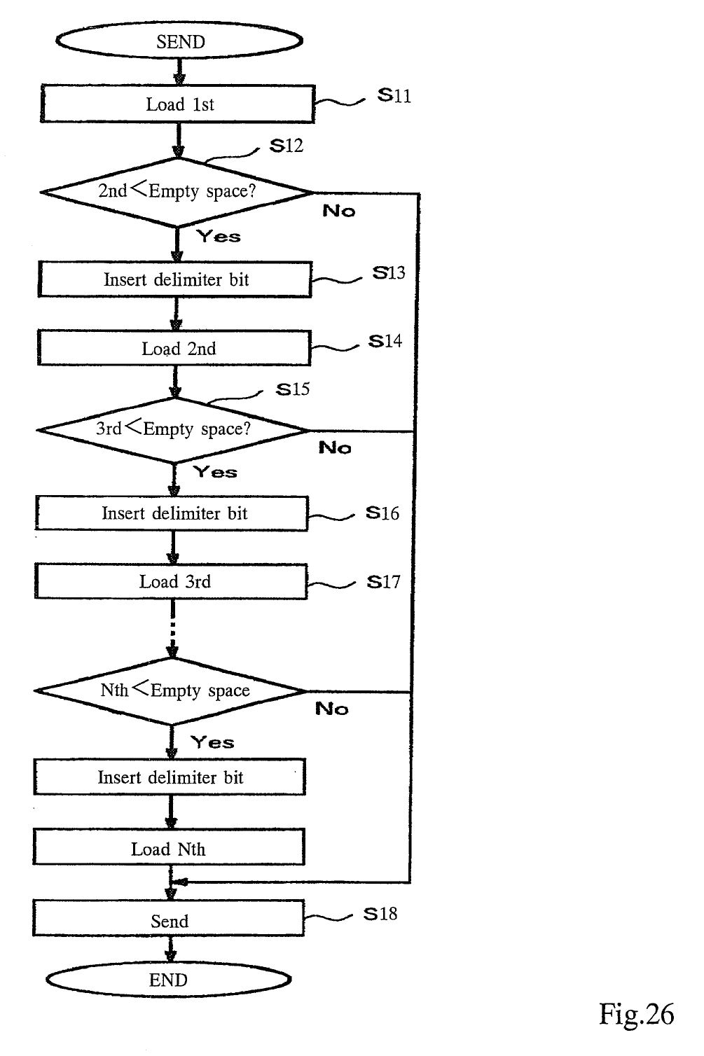

FIG. 26 shows the sequence of procedures conducted by the customer station 2 for loading data frames to be sent into the fixed-length data signal field 35.

When data frames to be wirelessly transmitted to the base station 1 occur in the customer station 2, the customer station 2 successively stores them in the buffer 11. When a data frame has been stored in the buffer 11, the loader 13 extracts the first data frame stored in the buffer 11 (1^{st} E frame) and loads it in the data signal field 35 of the upload/download data communications channel 24 (step S11).

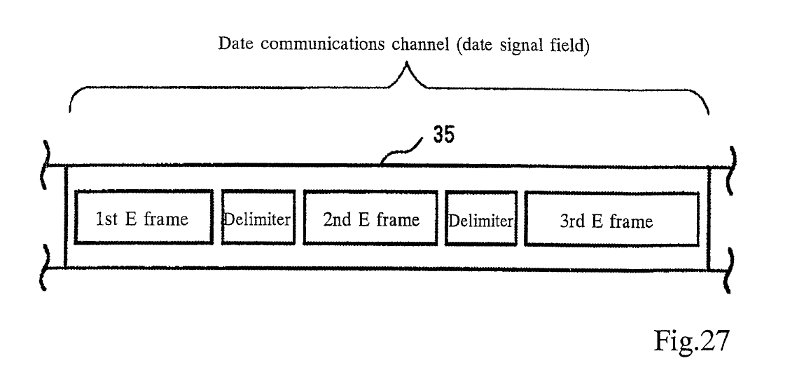

The size discriminator 12 then extracts the next data frame stored in the buffer 11 (2^{nd} E frame) and compares its size with the size of the empty region of the data signal field in which the 1^{st} E frame was loaded (step S12). If an empty region for storing the 2^{nd} E frame is found to be available, the loader 13 inserts a delimiter for indicating the boundary between the 1^{st} E frame and the 2^{nd} E frame as shown in FIG. 27 (step S13) and loads the 2^{nd} E frame in the same data signal field 35 as the 1^{st} E frame (step S14).

The size discriminator 12 then extracts the next frame stored in the buffer 11 (3^{rd} E frame), compares its size with the size of the empty region of the data signal field 35 in which the 1^{st} E frame and 2^{nd} E frame were loaded (step S15) and, if an empty region for storing the 3^{rd} E frame is available, the loader 13 inserts a delimiter for indicating the boundary between the 2^{nd} E frame and the 3^{rd} E frame as shown in FIG. 27 (step S16) and loads the 3^{rd} E frame in the same data signal field 35 as the ₁st E frame and the 2^{nd} E frame (step S17).

Thus, each successive E frame is loaded in the same data signal field 35 so long as the size of the empty region remaining in the fixed-length data signal field 35 is big enough to hold it. When the data signal field 35 no longer has enough empty space to hold another E frame, the communications unit 14 wirelessly transmits it to the base station 1 (step S18).

In an actual TDMA/TDD system, since the data communications channels are periodically transmitted during discrete fixed periods, the foregoing loading procedure can be conducted during the interval between send periods. The loading procedure therefore does not cause any transmission delay.

Although the foregoing embodiment was explained taking a customer station 2 as an example, the present invention can likewise be applied to the base station 1 to realize similar effective utilization of the wireless transmission medium.

Moreover, the present invention is not limited in application to a subscriber wireless access system or to a TDMA/TDD system, but can be implemented in an extensive range of wireless communication systems using fixed-length data communications channels to achieve similar effective utilization of the wireless transmission medium.

As explained in the foregoing, the present invention enables efficient use of fixed-length data communications channels in wireless communication and, by this, helps to ensure effective utilization of the wireless transmission medium. The effective utilization of a limited wireless transmission medium made possible by the present invention is a particular advantage in a subscriber wireless access system limited to a narrow band such as the submillimeter-wave or millimeter-wave band, because it increases the number of customers that can be accommodated per base station and thus enables provision of excellent communications services.

What is claimed is:

1. A wireless transmission system for conducting data transmission over a wireless field in which data transmission slots of a fixed size are periodically allocated to the wireless field, the wireless transmission system comprising:
a memory for retaining a wireless send queue whose members are transmission data awaiting transmission;
linking means for linking multiple transmission data to form members of the wireless send queue;
wireless send means for loading a wireless send queue member output from the memory in a data transmission slot; and
control means responsive to output of a wireless send queue member from the memory for controlling retention of a next wireless send queue member in the memory.

2. A wireless transmission system according to claim 1, wherein the control means monitors the number of wireless send queue members retained in the memory and effects control for retaining the next wireless send queue member in the memory when no wireless send queue member is retained or the number of retained wireless send queue members is smaller than at the time of the preceding memory output.

3. A wireless transmission system according to claim 1, wherein the control means effects control for retaining the next wireless send queue member in the memory synchronously with output of a wireless send queue member from the memory.

4. A wireless transmission system for conducting data transmission over a wireless field in which data transmission slots of a fixed size are periodically allocated to the wireless field, the wireless transmission system comprising:
a memory for retaining a wireless send queue whose members are transmission data awaiting transmission;
linking means for successively linking and inserting multiple transmission data in the members of the wireless send queue retained in the memory;
wireless send means for loading a wireless send queue member output from the memory in a data transmission slot; and
control means, responsive to output from the memory of a wireless send queue member under link/insertion processing or to a condition in which loading of next transmission data in a wireless send queue member under link/insertion processing would make its size larger than the data transmission slot, for shifting the processing of the linking means to processing for linking and inserting transmission data in the next wireless send queue retained in the memory.

5. A wireless transmission system according to claim 4, wherein:
the memory and control means are constituted as a physical module connected to an internal bus;
the module is provided with a bus interface for forwarding a wireless send queue member output from the memory to the wireless send means; and
the control means compares the size of an empty region of the wireless send queue member under link/insertion processing with the size of the next transmission data to be linked and inserted and shifts the link/insertion processing to the next wireless send queue member.

6. A wireless transmission system for conducting wireless communication between a base station and at least one customer station using fixed-length data communications channels, the wireless transmission system comprising:
a buffer for retaining frames to be sent in at least one of the base station and the customer station;
a comparing means for comparing the size of a frame to be sent retained in the buffer and the size of an empty region of a wireless send queue member; and
loading means for loading a lodable number of frames to be sent in the same data communications channel.

7. A wireless transmission system for conducting wireless communication using fixed-length data communications channels, the wireless transmission system comprising:
a buffer for retaining frames to be sent;
a comparing means for comparing the size of a frame to be sent retained in the buffer and the size of an empty region of a data communications channel; and
loading means for loading a lodable number of frames to be sent in the data communications channel.

8. A wireless transmission system according to claim 7, wherein the multiple frames to be sent are loaded in a single data communications channel together with intervening data for indicating their boundaries.
